(19) United States
(12) Patent Application Publication
(10) Pub. No.: US 2011/0189571 A1
(43) Pub. Date: Aug. 4, 2011

(54) FUEL CELL SYSTEM AND METHOD OF CONTROLLING FUEL GENERATING REACTION AND COMPUTER

(75) Inventors: Kuo-Tai Hung, Hsinchu County (TW); Cheng Wang, Hsinchu County (TW); Po-Kuei Chou, Hsinchu County (TW)

(73) Assignee: YOUNG GREEN ENERGY CO., HSINCHU COUNTY (TW)

(21) Appl. No.: 13/013,836

(22) Filed: Jan. 26, 2011

(30) Foreign Application Priority Data
Feb. 4, 2010 (CN) 201010112989.7

(51) Int. Cl. H01M 8/04

(52) U.S. Cl. 429/431; 429/443; 429/432; 429/442; 429/444

(57) ABSTRACT

A method of controlling a fuel generating reaction of a fuel cell includes: a. providing a first reactant; b. activating the first reactant to generate fuel to the fuel cell; c. when a characteristic value of the fuel cell reaches a first reference value during the activation, adding a quantity of a second reactant to the first reactant to determine a monitoring time; d. after the monitoring time, detecting the characteristic value of the fuel cell to acquire a first characteristic value; e. if the first characteristic value is lower than the first reference value, performing step d.; f. if the first characteristic value is higher than the first reference value, detecting the characteristic value of the fuel cell to acquire a second characteristic value after a delay time; and g. if the second characteristic value is lower than the first reference value, proceeding to step d.

### CROSS-REFERENCE TO RELATED APPLICATION

This application claims the priority benefit of China application serial no. 201010112989.7, filed on Feb. 4, 2010. The entirety of the above-mentioned patent application is hereby incorporated by reference herein and made a part of this specification.

### BACKGROUND OF THE INVENTION

1. Field of the Invention

The invention relates to a fuel cell, and more particularly, to a fuel cell system and a method of controlling a fuel generating reaction.

2. Description of Related Art

Development and application of energy have always been indispensable in daily lives; however, energy development and application also damage the environment increasingly. Generating energy with fuel cells has several advantages such as high efficiency, low noise level, and pollution-free. Accordingly, the fuel cell is a trend for energy.

A conventional fuel cell system generally includes a fuel cartridge and a fuel cell. Herein, the fuel cartridge is used to provide fuel cell with hydrogen gas (H₂) required for generating power. In the fuel cell, hydrogen gas causes a chemical reaction to generate power which is supplied to an electronic system.

In general, traditional cartridges usually apply a one-time reaction of boron compound hydrogen storage technique, in which H₂O is added, so that the boron compound chemically reacts to generate H₂ to fuel cells. However, the design of traditional cartridges includes one large chamber and the chemical reaction underwent by using the boron compound hydrogen storage technique in these cartridges is a one-time reaction. Thus, H₂ is persistently generated and this generation is stopped until the chemical reaction of boron compound, for example, sodium borohydride (NaBH₄), and H₂O is complete.

Since the generation of H₂ with chemical reaction leads to inconsistent H₂ flow, a flow control valve is usually required after the chemical reaction generates H₂ so as to stabilize the supply of H₂. Currently, manufactures mostly adopt the flow control valve to control the flow of H₂ precisely. Although the flow control valve is expensive, the following issues would result if the flow control valve is omitted.

Firstly, operations may not adapt to different environmental temperatures. At low environmental temperature, large quantity of H₂ is generated; however, the temperature is too low such that H₂ is greatly consumed. At high environmental temperature, the quantity of H₂ is reduced; nevertheless, the temperature is too high so that the system may not cool down to the temperature suitable for fuel cell reaction.

Secondly, the quantity of H₂ may not be controlled. Large quantity of H₂ leads to rapid increase in the voltage and temperature of the fuel cell system. On the contrary, small quantity of H₂ results in voltage reduction. The lifetime of a fuel cell system would be rapidly shortened if an effective control method is not available.

Thirdly, the conventional control methods adopted by manufacturers widen the temperature range, such that the temperature becomes too high or too low. On the other hand, the temperature directly affects output performance and thereby reduces fuel utilization rate.

### SUMMARY OF THE INVENTION

The invention relates to a fuel cell system, a method of controlling a fuel generating reaction, and a compute. The invention is capable of effectively controlling the quantity of a reactant to be added and the time of adding the reactant, so that the fuel may be controlled stably.

Other purposes and advantages of the invention may be further illustrated by the technical features broadly embodied and described as follows.

In order to achieve one or a portion of or all of the purposes or other purposes, an embodiment of the invention provides a method of controlling a fuel generating reaction of a fuel cell. The method includes steps illustrated herein: step a. providing a first reactant; step b. activating the first reactant for generating a fuel to the fuel cell; step c. adding a quantity of a second reactant to the first reactant to determine a monitoring time when a characteristic value of the fuel cell reaches a first reference value during the activation of the first reactant, wherein the monitoring time is a time of the characteristic value changing from a second reference value to the first reference value after adding the quantity of the second reactant; step d. detecting the characteristic value of the fuel cell to acquire a first characteristic value after adding the quantity of the second reactant to the first reactant and after the monitoring time; step e. proceeding to the step d. if the first characteristic value is lower than the first reference value; step f. detecting the characteristic value of the fuel cell to acquire a second characteristic value after a delay time if the first characteristic value is higher than the first reference value; and step g. proceeding to the step d if the second characteristic value is lower than the first reference value.

An embodiment of the invention provides a computer capable of controlling a fuel generating reaction of a fuel cell. After the computer loads and executes a computer program, the method of controlling the fuel generating reaction is completed.

An embodiment of the invention provides a fuel cell system including a chamber, a supplying device, a fuel cell, and a control unit. The chamber has a first reactant. The supplying device determines a quantity of the second reactant supplied to the chamber according to a control signal. The first reactant and the second reactant cause a fuel generating reaction in the chamber to generate fuel. The fuel cell is coupled to the chamber for receiving the fuel so as to generate power. The control unit is electrically connected to the supplying device and the fuel cell for providing the control signal to the supplying device and monitoring a characteristic value of the fuel cell. The control unit performs the method of controlling the fuel generating reaction of the fuel cell as mentioned above.

In an embodiment of the invention, the first reactant includes a chemical hydrogen storage material.

In an embodiment of the invention, the first reactant includes sodium borohydride (NaBH₄).

In an embodiment of the invention, the second reactant includes a chemical hydrogen storage material.

In an embodiment of the invention, the second reactant includes water (H₂O).

In an embodiment of the invention, the step of activating the first reactant includes adding the second reactant into the first reactant persistently and slowly.

In an embodiment of the invention, the control unit controls the supplying device to stop adding the second reactant into the first reactant if the characteristic value of the fuel cell is higher than the maximum value; the control unit performs the step d. if the characteristic value of the fuel cell is lower than the minimum value.

In an embodiment of the invention, the characteristic value of the fuel cell includes one of an temperature, an output voltage, an output current, and an output power.

In an embodiment of the invention, the fuel includes hydrogen.

In the embodiments of the invention, the first reactant and the second reactant are stored in the chamber and the supplying device respectively. Moreover, the control unit detects the characteristic value of the fuel cell to output the control signal accordingly for controlling the supplying device to provide the second reactant. As a result, the quantity of the second reactant to be added within a unit time may be controlled effectively and the supply of fuel may also be stably controlled. In addition, the fuel cell system provided in the embodiments of the invention does not require the use of the flow control valve, and the manufacturing cost of the fuel cell system is thus reduced.

To make the above features and advantages of the invention more comprehensible, one (or several) embodiment(s) accompanied with drawings are described in detail as follows.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a frame diagram of a fuel cell system according to an embodiment of the invention.

FIG. 2 is a schematic view illustrating changes of temperature in a fuel cell according to an embodiment of the invention.

FIG. 3 is a flow chart showing a method of controlling a fuel generating reaction of a fuel cell according to an embodiment of the invention.

### DESCRIPTION OF EMBODIMENTS

It is to be understood that other embodiment may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

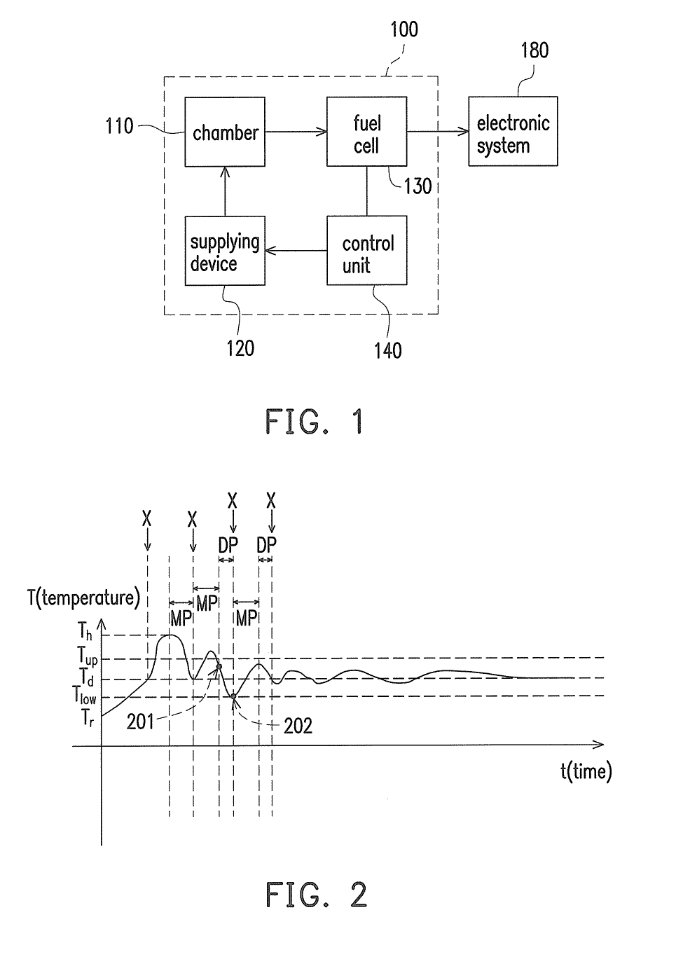

FIG. 1 illustrates a frame diagram of a fuel cell system 100 according to an embodiment of the invention. Referring to FIG. 1, the fuel cell system 100 is configured to supply power to an electronic system (loading) 180. The fuel cell system 100 includes a chamber 110, a supplying device 120, a fuel cell 130, and a control unit 140.

The chamber 110 has a first reactant. The supplying device 120 supplies the second reactant to the chamber 110, so that the first reactant and the second reactant in the chamber 110 cause a fuel generating reaction to generate fuel (i.e. H₂) to the fuel cell 130. In the embodiment, the first reactant may be any chemical hydrogen storage material and the first reactant is in a solid state or a liquid state, for example, NaBH₄, lithium hydride (LiH), and so on. However, the invention is not limited thereto. The second reactant may be any chemical hydrogen storage material, for example, H₂O; however, the invention is not limited thereto.

In the embodiment, when the first reactant contacts the second reactant, the resulting chemical equations include the following equations, but are not limited thereto.

1.[CH₃N(H)BH₂]3→[CH₃NBH]₃+3H₂;

2.nNH₄X+4MHₙ→Mxₙ+M₃Nₙ+4nH₂;

3.N₂H₆X₂+8/nMHₙ→2/nMxₙ+2/nM₃Nₙ+7H₂;

4.(NH₄)₂SO₄+16/nMHₙ→4M_{2/n}O+M_{2/n}S+2/nM₃Nₙ+12H₂;

5.N₂H₆SO₄+16/nMHₙ→4M_{2/n}O+M_{2/n}S+2/nM₃Nₙ+11₂;

6.LiBH₄→LiH+B+(3/2)H₂;

7.Ni+2H₂O→Ni(OH)₂+H₂;and

8.NaBH₄+2H₂O→NaBO₂+4H₂.

The fuel cell 130 is coupled to the chamber 110 for receiving the fuel (i.e. H₂) generated by the chamber 110, so as to convert the fuel into power to be supplied to the electronic system 180.

In the embodiment, the fuel cell 130 may be a proton exchange membrane fuel cell (PEMFC) or a direct methanol fuel cell (DMFC), but is not restrained thereto. Take PEMFC as an example, PEMFC is constituted by a proton exchange membrane, a thode, and an anode. Herein, the fuel of the anode of the fuel cell 130 reacts with a catalyst to generate hydrogen ions and electrons, and a chemical equation thereof is presented as follows:

2H₂→4H⁺+4e⁻.

Additionally, the electrons generated from the anode of the fuel cell 130 return to the cathode of the fuel cell 130 through various circuits such as the electronic system 180 and the like. The hydrogen ions generated from the anode pass through the proton exchange membrane inside the fuel cell 130 and move toward the cathode. The hydrogen ions react with the electrons and oxygen at the cathode of the fuel cell 130 to generate H₂O, where a chemical formula thereof is shown below:

4H⁺+4e⁻+O₂→2H₂O.

Thus, the overall chemical reaction of the PEMFC is represented herein:

2H₂+O₂→2H₂O.

The means of the fuel cell 130 generating power is known to persons skilled in the art, and thus not repeated hereinafter. Persons applying the embodiment are capable of implementing the fuel cell system 100 using any type of fuel cells 130 now present or manufactured in the future.

The control unit 140 is electrically connected to the supplying device 120 and the fuel cell 130. The control unit 140 is configured for monitoring a characteristic value of the fuel cell 130 and providing a control signal to the supplying device 120 so as to determine the quantity of the second reactant to be supplied to the chamber 110 by the supplying device 120 and a time thereof. In the embodiment, the characteristic value of the fuel cell 130 includes one of the following: temperature, output voltage, output current, and output power; nevertheless, the invention is not limited thereto.

In the following, the operation of the control unit 140 monitoring the characteristic value of the fuel cell 130 and providing the control signal to the supplying device 120 is illustrated according to the embodiment of the invention. To facilitate illustration, in the embodiment, the characteristic value of the fuel cell 130 is presumed to be temperature. That is, the control unit 140 monitors the temperature of the fuel cell 130 and thereby provides the control signal to the supplying device 120.

FIG. 2 is a schematic view illustrating changes of temperature in a fuel cell 130 according to an embodiment of the invention. Referring to FIGS. 1 and 2 simultaneously, the control unit 140 controls the supplying device 120 to add the second reactant (i.e. H₂O) persistently and slowly into the chamber 110 having the first reactant (i.e. sodium borohydride) when the fuel cell system 100 starts to operate. Consequently, the first reactant in the chamber 110 is activated (that is, the first reactant and the second reactant cause the fuel generating reaction) for generating fuel (i.e H₂) to the fuel cell 130. In the activation of the first reactant, since the fuel cell 130 converts the fuel into power, the temperature of the fuel cell 130 gradually increases from room temperature (i.e. Tᵣ marked in FIG. 2). Next, the control unit 140 stops the activation of the first reactant and controls the supplying device 120 to add a quantity (i.e. X milliliter) of the second reactant into the chamber 110 when the control unit 140 monitors the temperature of the fuel cell 130 to have reached a first reference value (i.e. T_{d} marked in FIG. 2).

Thereafter, in the fuel generating reaction of the second reactant and the first reactant, the temperature of the fuel cell 130 increases persistently from the first reference value T_{d} and reaches a second reference value (i.e. Tₕ marked in FIG. 2, which is presumed to be the highest temperature of the fuel cell 130 in the fuel generating reaction; however, the invention is not limited thereto). At this time, since the quantity of the second reactant has been consumed completely, the temperature of the fuel cell 130 begins to decrease from the second reference value Tₕ (the highest temperature in the fuel generating reaction). When the temperature of the fuel cell 130 decreases to the first reference value T_{d}, the control unit 140 then defines the time (time for the temperature of the fuel cell 130 to decrease from the second reference value Tₕ to the first reference value T_{d}) as a monitoring time (i.e. MP marked in FIG. 2), so that the control unit 140 is capable of detecting the temperature of the fuel cell 130 every monitoring time MP.

After the monitoring time MP is determined, the control unit 140 controls the supplying device 120 to add the same quantity (X mL) of the second reactant to the chamber 110, so that the second reactant and the first reactant cause another fuel generating reaction. Thereafter, the control unit 140 detects the temperature of the fuel cell 130 after the monitoring time MP to acquire a first temperature (that is, a first characteristic value, such as 201 marked in FIG. 2) and compares the first temperature 201 with the first reference value T_{d}.

If the first temperature 201 is higher than the first reference value T_{d}, the control unit 140 re-detects the temperature of the fuel cell 130 after a delay time (i.e. a time period DP marked in FIG. 2) to acquire a second temperature (that is, a second characteristic value, such as 202 marked in FIG. 2). Moreover, the control unit 140 compares the second temperature 202 with the first reference value T_{d}. In the embodiment, the delay time DP is, for example, 1/10 of the monitoring time MP; however, the invention is not limited thereto.

If the second temperature 202 is lower than the first reference value T_{d}, the control unit 140 controls the supplying device 120 to add the same quantity (X mL) of the second reactant to the chamber 110, so that the second reactant and the first reactant cause another fuel generating reaction and repeat the foregoing process. That is, after the monitoring time MP, the temperature of the fuel cell 130 is re-detected to acquire a new detected temperature.

On the other hand, if the second characteristic value is higher than the first reference value T_{d}, the control unit 140 re-detects the temperature of the fuel cell 130 after another delay time DP to acquire another temperature (that is, another characteristic value). Afterwards, the control unit 140 compares the another temperature with the first reference value T_{d}. If the another temperature is higher than the first reference value T_{d}, the control unit 140 re-detects the temperature of the fuel cell 130 after the delay time DP, until the detected temperature of the fuel cell 130 is lower than the first reference value T_{d} (that is, the characteristic value of the fuel cell 130 is lower than the first reference value T_{d}). The control unit 140 then outputs the control signal to the supplying device 120 for the supplying device 120 to supply the same quantity (X mL) of the second reactant to the chamber 110 again.

Accordingly, if the control unit 140 detects the first temperature 201 (that is, the first characteristic value) lower than the first reference value T_{d} after the monitoring time MP, the control unit 140 controls the supplying device 120 to add the same quantity (X mL) of the second reactant into the chamber 110. Therefore, the fuel cell system 100 provided in the embodiment is capable of controlling the quantity of the second reactant to be added and the time of addition effectively so as to further control the quantity of the fuel (H₂) effectively.

Furthermore, in the embodiment, a maximum value and a minimum value, respectively shown as Tᵤₚ and T_{low} in FIG. 2, are set in the control unit 140. In other words, the control unit 140 controls the supplying unit 120 to stop adding the second reactant into the chamber 110 when the control unit 140 detects the temperature of the fuel cell 130 to have exceeded the maximum value Tᵤₚ. When the control unit 140 detects the temperature of the fuel cell 130 lower than the minimum value T_{low}, the control unit 140 controls the supplying device 120 to add the quantity of the second reactant into the chamber 110, such that the first reactant continues to react with the second reactant so as to provide the fuel (H₂) to the fuel cell 130 for generating power. The fuel cell system 100 provided in the embodiment is capable of controlling the time of adding the second reactant, so that the fuel (quantity of H₂) may be controlled stably.

In the embodiment aforementioned, the characteristic value of the fuel cell 130 may be temperature. Nonetheless the invention is not limited thereto. The characteristic value of the fuel cell 130 may also be one of the output voltage, the output current, and the output power. The embodiments after replacing the characteristic values may also refer to the above descriptions, and details thereof are omitted hereinafter.

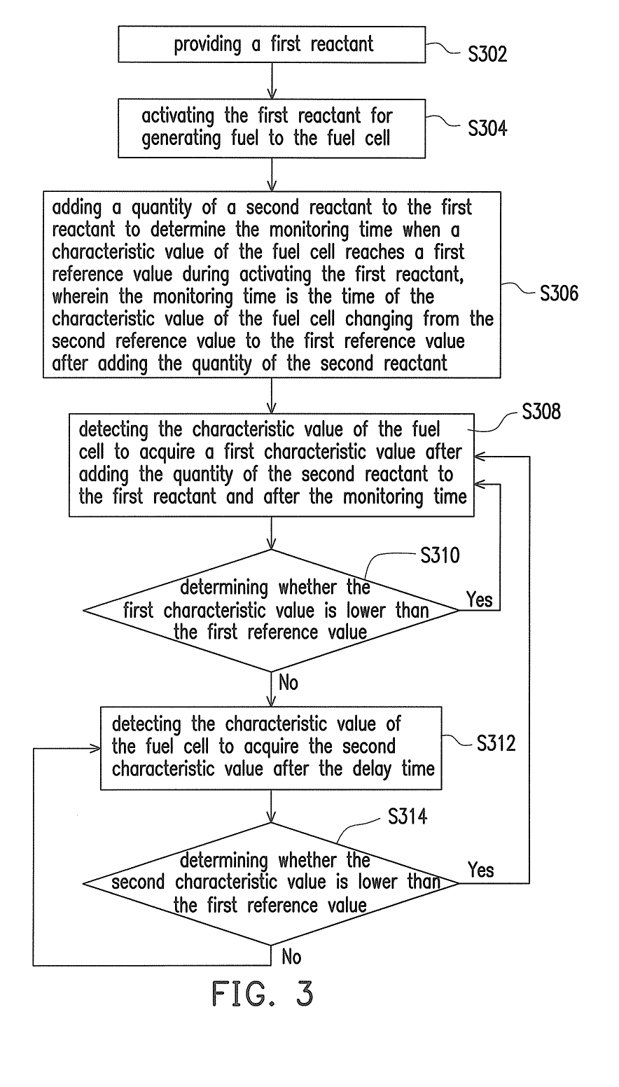

The operating process of the fuel cell system 100 may be listed out as the following method of controlling the fuel generating reaction of the fuel cell 130. FIG. 3 is a flow chart showing a method of controlling a fuel generating reaction of a fuel cell according to an embodiment of the invention. Referring to FIG. 3, in step S302, a first reactant (i.e. sodium borohydride) is provided firstly. In step S304, the first reactant is activated to generate fuel to the fuel cell 130. In step S304, the second reactant (i.e. H₂O) is added into the first reactant persistently and slowly so as to activate the first reactant (that is, the first reactant and the second reactant cause the fuel generating reaction).

In step S306, a quantity of the second reactant is added into the first reactant to determine a monitoring time when a characteristic value (i.e. temperature, output voltage, output current, or output power) of the fuel cell 130 reaches a first reference value during the activation of the first reactant. Herein, the monitoring time is a time of the characteristic value of the fuel cell 130 changing from a second reference value to the first reference value after adding the quantity of the second reactant. In step S308, the quantity of the second reactant is added to the first reactant and the characteristic value of the fuel cell 130 is detected to acquire a first characteristic value after the monitoring time.

In step S310, if the first characteristic value is determined to be lower then the first reference value, step S308 is proceeded. In other words, the quantity of the second reactant is added to the first reactant again. On the other hand, in step S310, if the first characteristic value is determined to be higher than the first reference value, then step S312 is carried out to detect the characteristic value of the fuel cell 130 to acquire a second characteristic value after a delay time.

In step S314, if the second characteristic value is determined to be lower then the first reference value, step S308 is performed. That is, the quantity of the second reactant is added to the first reactant again. On the other hand, in step S314, if the second characteristic value is determined to be higher than the first reference value, then step S312 is carried out to detect the characteristic value of the fuel cell 130 after the delay time. Afterwards, steps S312, S313 and S314 are repeated until the characteristic value of the fuel cell 130 detected is lower than the first characteristic value.

Moreover, a maximum value and a minimum value are set in the method of controlling the fuel generating reaction of the fuel cell 130 in the embodiment. That is to say, after the monitoring time has been dete mined, if the characteristic value of the fuel cell 130 is higher than the maximum value, the addition of the second reactant into the first reactant is stopped. If the characteristic value of the fuel cell 130 is lower than the minimum value, step S308 is then performed.

The method of controlling the fuel generating reaction of the fuel cell 130 illustrated in the embodiments above may also be implemented as a computer under certain application demands. The computer program stored in a storage medium may be accessed by a computer. This computer may be broadcasted using Internet media. After the computer loads and executes the computer program in combination with the foregoing fuel cell system, the method of controlling the fuel generating reaction may be completed.

In summary, the forementioned embodiments have at least one of the following advantages: since the first reactant (e.g. sodium borohydride) and the second reactant (e.g. H₂O) are stored in the chamber 110 and the supplying device 120 respectively and the control unit 140 detects the characteristic value of the fuel cell 130 to output the control signal accordingly for controlling the supplying device 120, the quantity of the second reactant to be added and the time of adding the second reactant may be controlled effectively, such that the supply of fuel (i.e. H₂) may be stably controlled. In addition, the fuel cell system 100 provided in the embodiments of the invention does not require the use of the flow control valve, and the manufacturing cost of the fuel cell system 100 is thus reduced. The forementioned embodiments further include at least one of the following effects.

1. The control unit 140 controls the time of adding the second reactant (i.e. time of adding water), so that the fuel (quantity of H₂) may be stably controlled according to the method of controlling the fuel generating reaction of the fuel cell 130 provided in the foregoing embodiments.

2. The method may be operated under different environmental temperatures and suitable characteristic time (that is, the monitoring time) is automatically defined along with different environmental temperatures.

3. The embodiment of the invention is capable of changing the detecting time along with the performance of the fuel system 100 as the performance of the fuel cell system 100 reduces, so that false determination does not occur as the performance reduces.

4. Temperature, output voltage, output current, or output power may all be adopted as the determination indicator (that is, the characteristic value of the fuel cell 130) of the invention. Consequently, errors resulted from uttering may be improved.

The foregoing description of the preferred embodiments of the invention has been presented for purposes of illustration and description. It is not intended to be exhaustive or to limit the invention to the precise foim or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the disclosure is intended to be dedicated to the public regardless of whether the element or component is explicitly recited in the following claims.

What is claimed is:

1. A method of controlling a fuel generating reaction of a fuel cell, comprising following steps:
step a. providing a first reactant;
step b. activating the first reactant for generating a fuel to the fuel cell;
step c. adding a quantity of a second reactant to the first reactant to determine a monitoring time when a characteristic value of the fuel cell reaches a first reference value during activating the first reactant, wherein the monitoring time is a time of the characteristic value changing from a second reference value to the first reference value after adding the quantity of the second reactant;
step d. detecting the characteristic value of the fuel cell to acquire a first characteristic value after adding the quantity of the second reactant to the first reactant and after the monitoring time;
step e. proceeding to the step d. if the first characteristic value is lower than the first reference value;
step f. detecting the characteristic value of the fuel cell to acquire a second characteristic value after a delay time if the first characteristic value is higher than the first reference value; and
step g. proceeding to the step d. if the second characteristic value is lower than the first reference value.

2. The method of controlling the fuel generating reaction of the fuel cell as claimed in claim 1, wherein the first reactant comprises a chemical hydrogen storage material.

3. The method of controlling the fuel generating reaction of the fuel cell as claimed in claim 1, wherein the first reactant comprises sodium borohydride.

4. The method of controlling the fuel generating reaction of the fuel cell as claimed in claim 1, wherein the second reactant comprises a chemical hydrogen storage material.

5. The method of controlling the fuel generating reaction of the fuel cell as claimed in claim 1, wherein the second reactant comprises water.

6. The method of controlling the fuel generating reaction of the fuel cell as claimed in claim 1, wherein the step of activating the first reactant comprises:
adding the second reactant into the first reactant persistently and slowly.

7. The method of controlling the fuel generating reaction of the fuel cell as claimed in claim 1, further comprising:
stopping adding the second reactant into the first reactant if the characteristic value of the fuel cell is higher than a maximum value; and
proceeding to the step d. if the characteristic value of the fuel cell is lower than a minimum value.

8. The method of controlling the fuel generating reaction of the fuel cell as claimed in claim 1, wherein the characteristic value of the fuel cell comprises one of a temperature, an output voltage, an output current, and an output power.

9. The method of controlling the fuel generating reaction of the fuel cell as claimed in claim 1, wherein the fuel comprises hydrogen.

10. A computer capable of controlling a fuel generating reaction of a fuel cell, completing the method of controlling the fuel generating reaction as claimed in claim 1 after the computer loads and executes a computer program.

11. A fuel cell system, comprising:
a chamber, having a first reactant;
a supplying device, capable of determining a quantity of a second reactant supplied to the chamber according to a control signal, wherein the first reactant and the second reactant cause a fuel generating reaction in the chamber to generate a fuel;
a fuel cell, coupled to the chamber for receiving the fuel so as to generate power; and
a control unit, electrically connected to the supplying device and the fuel cell for providing the control signal to the supplying device and monitoring a characteristic value of the fuel cell, wherein the control unit performs the method of controlling the fuel generating reaction as claimed in claim 1.

12. The fuel cell system as claimed in claim 11, wherein the first reactant comprises a chemical hydrogen storage material.

13. The fuel cell system as claimed in claim 11, wherein the first reactant comprises sodium borohydride.

14. The fuel cell system as claimed in claim 11, wherein the second reactant comprises a chemical hydrogen storage material.

15. The fuel cell system as claimed in claim 11, wherein the second reactant comprises water.

16. The fuel cell system as claimed in claim 11, wherein the step of activating the first reactant comprises:
adding the second reactant into the first reactant persistently and slowly.

17. The fuel cell system as claimed in claim 11, wherein the control unit controls the supplying device to stop adding the second reactant into the first reactant if the characteristic value of the fuel cell is higher than a maximum value; and the control unit performs the step d. if the characteristic value of the fuel cell is lower than a minimum value.

18. The fuel cell system as claimed in claim 11, wherein the characteristic value of the fuel cell comprises one of a temperature, an output voltage, an output current, and an output power.

19. The fuel cell system as claimed in claim 11, wherein the fuel comprises hydrogen.
